(19) United States
(12) Patent Application Publication
(10) Pub. No.: US 2013/0110531 A1
(43) Pub. Date: May 2, 2013

(54) Method for reducing healthcare costs

(71) Applicant: Kenneth O Russell, Austin, TX (US)

(72) Inventor: Kenneth O Russell, Austin, TX (US)

(21) Appl. No.: 13/317,824

(22) Filed: Oct. 29, 2011

(51) Int. Cl. G06Q 50/22

(52) U.S. Cl. 705/2

(57) ABSTRACT

A method of increasing the endocrine health of users comprising an awareness of recent scientific discoveries, training in the basic science, introduction of products which implements the science, a personal coaching system to ensure the user understands and is experiencing the benefits of this system and a feedback mechanism to adjust the implementation of the system disclosed herein for optimum results.

### CROSS-REFERENCE TO RELATED APPLICATIONS

This application is a provisional application that relates to the following patent applications: U.S. application Ser. No. 12/069,505 filed on Feb. 13, 2008, U.S. application Ser. No. 61/159,893 filed on Mar. 13, 2009, and U.S. Application Ser. No. 61/397,817 filed on Jun. 16, 2010; all of which are incorporated by reference herein in their entirety.

### STATEMENT REGARDING FEDERALLY SPONSORED RESEARCH OR DEVELOPMENT

Not applicable.

### BACKGROUND OF THE INVENTION

1. Field of the Invention

This invention relates to the field of personal health, and more specifically to a method reducing healthcare costs by implementing the previous patent methods and products of Kenneth O. Russell regarding iron/chromium optimization, and with additional essential components of human health (e.g. Vitamin D, Iodine, Caffeine, Vitamin B, et al) to the public, to employers, to health care plans, any individuals or groups of people.

2. Background of the Invention

Inventor Kenneth O. Russell has applied for U.S. Patents for several products related to health care, specifically for the uptake of nutrients into cells, for the reduction of blood glucose levels and for the general enhancement of cellular health (see above). There is a need for the development of methods for introducing the above advancements into the marketplace. This Patent application discloses such methods.

### BRIEF SUMMARY OF SOME OF THE PREFERRED EMBODIMENTS

This patent application discloses a business model which includes a method to introduce the science of chromium/iron control to consumers. The method consists of several steps, comprising: introducing the science through, but not limited to, informational seminars, brochures, one-on-one counseling, presentations at business meetings, talks at group gatherings, internet websites or other methods. However, since the science being presented is unfamiliar to most people, it is necessary to follow the information with an application program for implementing the newly gained knowledge into daily life. In addition, the products, which are the subject of related patents, and which have been developed to enhance health, should be explained, demonstrated and the potential user coached in their use. The results experienced by a user of the patented products can vary widely depending on the details of the application. Thus, a coaching system should be part of the method. Finally, a feedback mechanism, to confirm the optimum use of the patented products, needs to be provided so the user is not left by him/herself and is thus encouraged to get the most benefit from the program.

The business method of the present invention may also include the step of disseminating the information without fee or charge to the recipient, for charitable purposes or to create business relationships, where value can accrue to the donor by indirect means.

### DETAILED DESCRIPTION OF THE PREFERRED EMBODIMENTS

Science. The science of human endocrinology is well laid out in the scientific literature. However, the information, in its interactive totality, is not generally understood by even the medical community, let alone by the general population. An attached addendum presents a summary of the science involved, with liberal references to published scientific journals in which all the pieces can be found. The preferred embodiment of this patent involves introducing some or all of the covered science prior to the introduction of products developed to reduce the knowledge into practice.

In order to get the science of Chromium Endocrinology into the hands of the people needing the application thereof in their daily lives, it is necessary to disseminate the information widely. Methods to be used are the general information dissemination mechanisms common to today's society. Dr. Francisco Facchini has obtained a U.S. Letters Patent on controlling diabetes through regular phlebotomies (U.S. Pat. No. 6,147,070). His patent makes no claim to protection for the act of conducting phlebotomies, only insofar as they are used in the reduction of blood Iron through following the methods of his patent. This patent disclosure, similarly, makes no claim of protection for any of the numerous vehicles of information dissemination, except as they pertain to the disclosure of the information related to Chromium's role in human endocrinology.

Application of the Science. Once the recipients have had the science of Chromium Endocrinology explained to them, it is necessary to show them how this knowledge can be of utility to them. Thus, they need to have some demonstration of utility. One embodiment of this demonstration could be by taking their current blood sugar reading, applying the products associated with this patent, undergoing a mild exercise period, then once again taking a blood sugar reading. An alternate embodiment would be to apply products developed to utilize the science then undergo a strenuous exercise regimen and compare their performance to previous periods of similar difficulty. A third embodiment could be applying the associated products immediately prior to bedtime and logging the quality of the resultant sleep the next morning, after waking.

Products. The products which constitute part of this disclosure are the products created in conformance with the previous patent applications noted above or similar products yet to be developed (by the inventor or others) implementing the science as taught. These products would contain some combination of, but not limited to, the following chemicals: Chromium salts, Magnesium Sulfate (Epsom Salt), Vitamin D, Vitamin B, Whey Protein, and Caffeine. The products could be formulated so as to facilitate application topically to the surface of the skin of the user. Further products to be included consist of over-the-counter neutraceuticals which have been found efficacious in the enhancement of human endocrinology. This patent disclosure makes no claim for patent protection of said neutraceuticals for the inventor only except as they are part of the business method disclosed herein.

Coaching system. The preferred embodiment for implementing this coaching system is to have a cadre of personal coaches versed in the science and familiar with the products to be available to users on demand. An alternate embodiment is to have a dedicated website available to users from which they could read discussions, view short videos and download documents related to the implementation of the system.

Feedback mechanisms. Implementation of the necessary feedback mechanisms could entail periodic contact by the user's coach, follow-up seminars, and Periodic reports sent by the user to the coach, either through the mail or utilizing a dedicated website. Alternate feedback could be obtained through group coaching sessions, encouragement of peers (i.e., other users), or random telephonic surveys of users.

Without being limited by theory, the business method disclosed herein may result in the individual users having decreased fasting blood sugar, increased sleep quality, reduced depression, increased food satiety, enhanced stamina, shorter recovery times, reduced carbohydrate craving, increased weight loss, increased muscle mass and energy levels, reduced fatigue or increased athletic performance.

Although the present invention and its advantages have been described in detail, it should be understood that various changes, substitutions and alterations may be made herein without departing from the spirit and scope of the invention as defined by any claims.

I claim:

1. A business method for reducing health care costs consisting of:
A first step of introduction of the science of chromium endocrinology through the use of common dissemination procedures,
A second step of presentation of products for enhancing chromium endocrinology comprising a topically applied emulsion containing a trivalent chromium salt
A third step of coaching assistance for persons wishing to implement said method

2. The method of claim 1, wherein said first step comprises informational seminars, brochures, one-on-one counseling, presentations at business meetings, talks at group gatherings, internet websites or other methods.

3. The method of claim 1, wherein said emulsion further comprises magnesium sulfate, caffeine, cyano-cobalamine, di-methylamino ethanol, leucine, isoleucine, valine, dimethyl-sulfoxide.

4. The method of claim 1 wherein said second step further includes orally ingested neutraceutical products comprising Powdered protein, Vitamin D₃, Alpha lipoic acid, wheat grass extract, green tea extract, ethylene-diamine-tetra-acetic acid, Omega 3/6 fatty acids, Curcumin and Nifedipine.

5. The method of claim 4 wherein said orally ingested products further comprise the metal salts of copper, zinc, selenium and manganese.

6. The method of claim 1 wherein said third step comprises personal trainers, dedicated websites, printed literature and online webinars

7. The method of claim 1 wherein said method further consists of a fourth step of feedback monitoring.

8. The method of claim 7, wherein said feedback consists of periodic contact by a personal coach, said contact comprising personal visits, regular mail, e-mail and telephone.

9. The method of claim 7 wherein said feedback comprises follow-up seminars, a dedicated website, group coaching sessions, encouragement of other users, or random telephonic surveys of users.
